(19) United States
(12) Patent Application Publication
(10) Pub. No.: US 2016/0142672 A1
(43) Pub. Date: May 19, 2016

(54) AUTOMATIC SCREEN ADJUSTMENT FOR MULTI LOCATION VIDEO CONFERENCING

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, Kolkata (IN); Craig M. Trim, Sylmar, CA (US)

(21) Appl. No.: 14/542,767

(22) Filed: Nov. 17, 2014

(51) Int. Cl. H04N 7/15

(52) U.S. Cl. CPC H04N 7/15

(57) ABSTRACT

Aspects evenly distribute objects within video content from multiple video feeds across multiple, independent screen display elements. Positions of objects of interest are identified within each of a plurality of video feeds of a video conference. Dimensions of the identified positions of the objects of interest are determined. The video feeds are distributed across a plurality of video display elements as a function of the determined dimensions of the identified positions of the objects of interest, to evenly distribute the objects of interest across a cumulative available screen area provided by the plurality of video display elements, wherein the distributing includes differentially distributing portions of one of the video feeds across more than one of the plurality of screen display elements.

### BACKGROUND

Video conferencing systems may manage multiple, independent video feeds. Effectively presenting a plurality of different video feeds that each have different video and audio information to a single viewer may be problematic. Relative differences in quality, attenuation, strength of signal, or quality or clarity of audio and video signals or the information conveyed thereby may diminish the experience of the viewer with regard to one or more of the individual video feeds, interfering with establishing a true, multi-location conference setting.

### BRIEF SUMMARY

In one aspect of the present invention, a method evenly distributes objects within video content from multiple video feeds across multiple, independent screen display elements. Positions of objects of interest are identified within each of a plurality of video feeds of a video conference. Dimensions of the identified positions of the objects of interest are determined. The video feeds are distributed across a plurality of video display elements as a function of the determined dimensions of the identified positions of the objects of interest, to evenly distribute the objects of interest across a cumulative available screen area provided by the plurality of video display elements, wherein the distributing includes differentially distributing portions of one of the video feeds across more than one of the plurality of screen display elements.

In another aspect, a method provides a service for evenly distributing objects within video content from multiple video feeds across multiple, independent screen display elements. The method includes integrating computer-readable program code into a computer system including a hardware processing unit in circuit communication with a computer readable memory and a computer readable tangible storage medium. The computer readable program code includes instructions for execution by the processor that cause the processor to evenly distribute objects within video content from multiple video feeds across multiple, independent screen display elements. Thus, the processor identifies positions of objects of interest within each of a plurality of video feeds of a video conference; determines dimensions of the identified positions of the objects of interest; and distributes the video feeds across a plurality of video display elements as a function of the determined dimensions of the identified positions of the objects of interest, to thereby evenly distribute the objects of interest across a cumulative available screen area provided by the plurality of video display elements, wherein the distributing includes differentially distributing portions of one of the video feeds across more than one of the plurality of screen display elements.

In another aspect, a system has a hardware processor, computer readable memory in circuit communication with the processor, and a computer-readable storage medium in circuit communication with the processor and having program instructions stored thereon. The processor executes the program instructions stored on the computer-readable storage medium via the computer readable memory and thereby evenly distributes objects within video content from multiple video feeds across multiple, independent screen display elements. Thus, the processor identifies positions of objects of interest within each of a plurality of video feeds of a video conference; determines dimensions of the identified positions of the objects of interest; and distributes the video feeds across a plurality of video display elements as a function of the determined dimensions of the identified positions of the objects of interest, to thereby evenly distribute the objects of interest across a cumulative available screen area provided by the plurality of video display elements, wherein the distributing includes differentially distributing portions of one of the video feeds across more than one of the plurality of screen display elements.

In another aspect, a computer program product for evenly distributing objects within video content from multiple video feeds across multiple, independent screen display elements, has a computer-readable storage medium with computer readable program code embodied therewith. The computer readable program code includes instructions for execution by a processor that cause the processor to identify positions of objects of interest within each of a plurality of video feeds of a video conference; determine dimensions of the identified positions of the objects of interest; and distribute the video feeds across a plurality of video display elements as a function of the determined dimensions of the identified positions of the objects of interest, to thereby evenly distribute the objects of interest across a cumulative available screen area provided by the plurality of video display elements, wherein the distributing includes differentially distributing portions of one of the video feeds across more than one of the plurality of screen display elements.

### BRIEF DESCRIPTION OF THE SEVERAL VIEWS OF THE DRAWINGS

These and other features of embodiments of the present invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a flow chart illustration of a method or process according to the present invention for evenly distributing objects within video content from multiple video feeds across multiple, independent screen display elements.

FIG. 5 is a graphical depiction of a perspective of a participant in a conventional, multiple feed video conferencing system presentation.

FIG. 6 is a graphical depiction of a perspective of a participant in a multiple feed video conferencing system presentation according to the present invention.

FIG. 7 is a graphical depiction of a perspective of a participant in another multiple feed video conferencing system presentation according to the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. (“FIG.”) 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

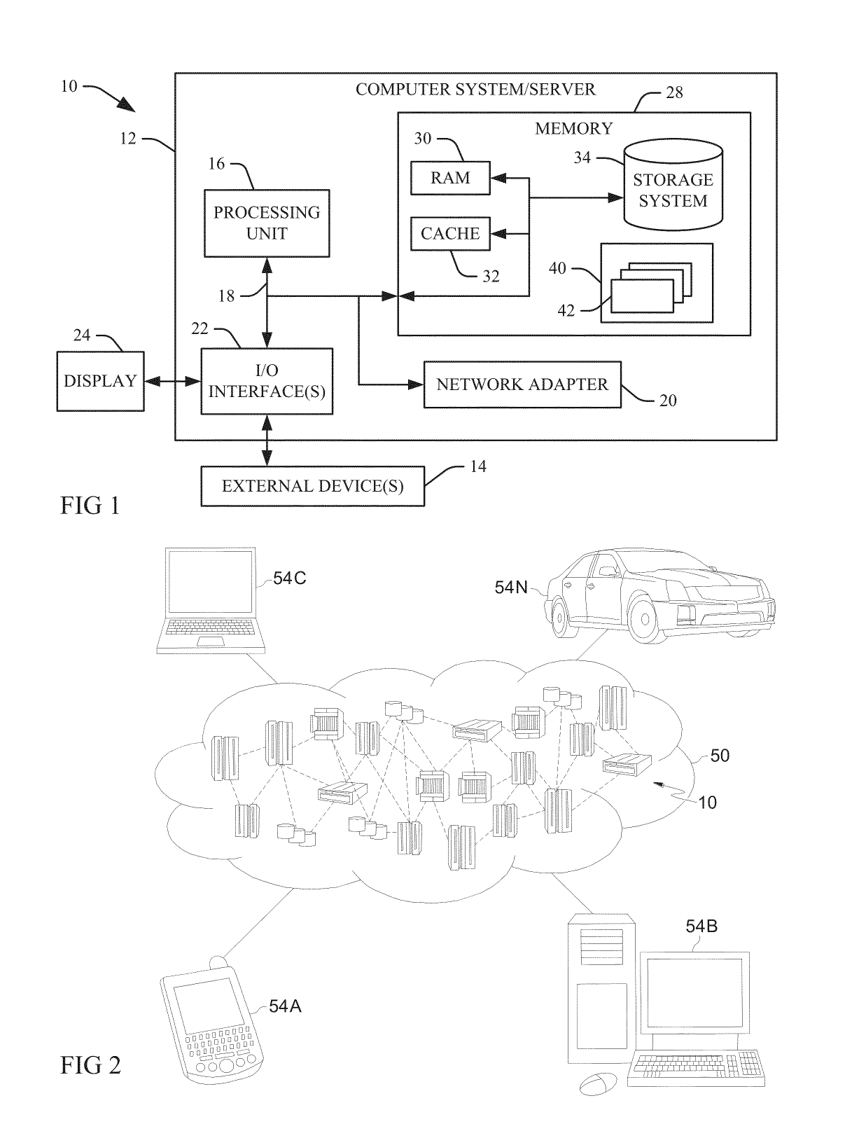

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media, can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of a non-limiting example, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that, although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

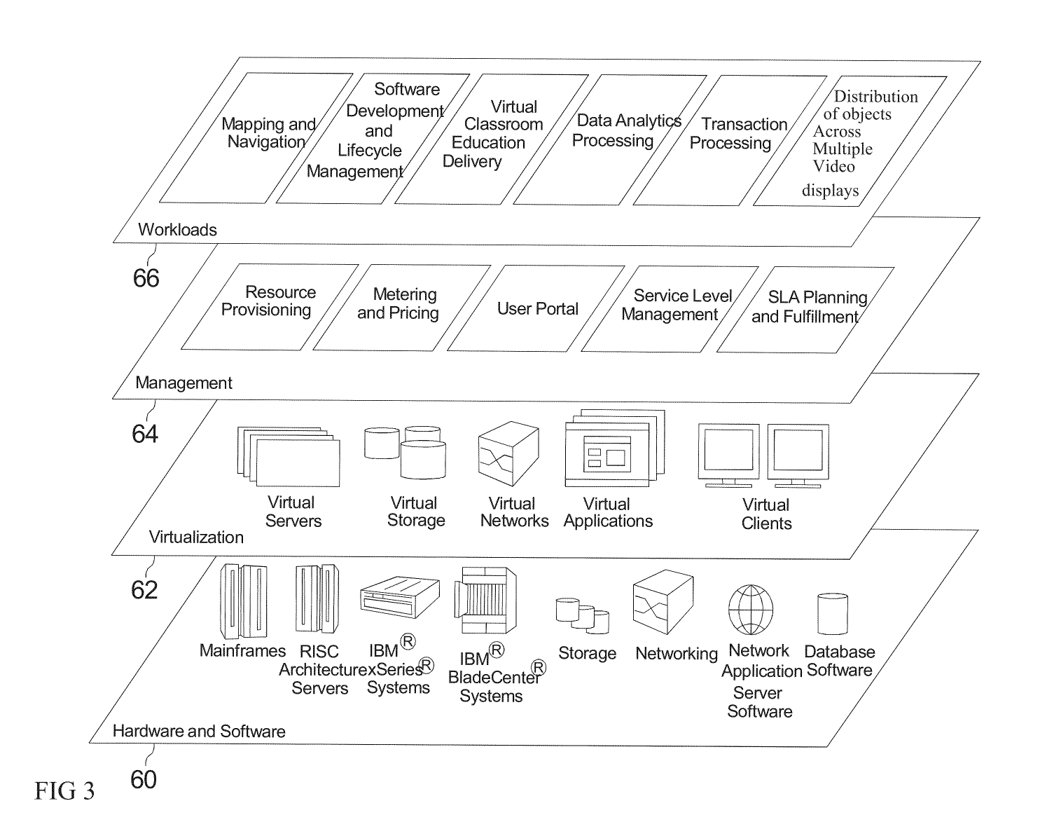

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and the distribution of objects within video content from multiple video feeds across multiple, independent screen display elements (as described more particularly below).

In one aspect, a service provider may perform process steps of the invention on a subscription, advertising, and/or fee basis. That is, a service provider could offer to integrate computer readable program code into the computer system/server 12 to enable the computer system/server 12 to perform process steps of the invention. The service provider can create, maintain, and support, etc., a computer infrastructure, such as the computer system 12, bus 18, or parts thereof, to perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 12, from a tangible computer readable medium device 34; (2) adding one or more computing devices to the computer infrastructure 10; and (3) incorporating and/or modifying one or more existing systems 12 of the computer infrastructure 10 to enable the computer infrastructure 10 to perform process steps of the invention.

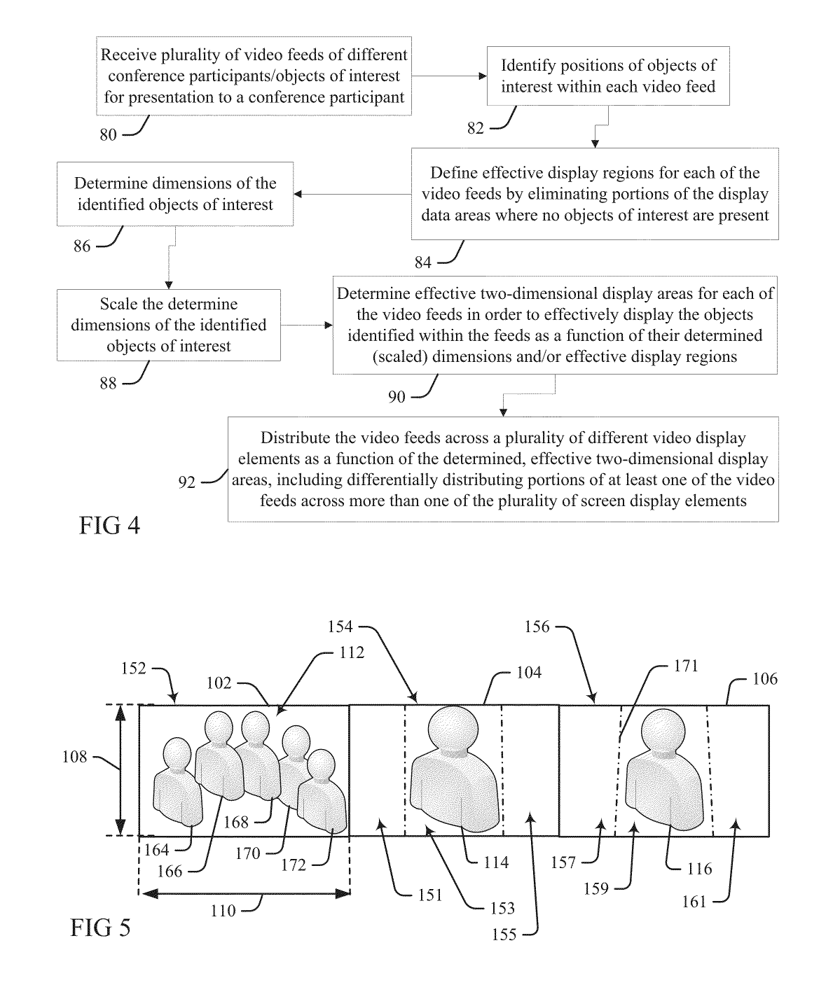

FIG. 4 illustrates a method or process of an aspect of the present invention for evenly distributing objects within video content from multiple video feeds across multiple, independent screen display elements. Display area portions each of a plurality of feeds may be automatically allocated and adjusted by at least one computing device to accommodate the display of objects of interest within the respective video contents. More particularly, at 80 a video conferencing system receives a plurality of video feeds that each include different participants and/or objects of interest participating in a video conference, for presentation to at least one audio-visual conference participant in another, different location. The feeds and participants are typically from (or in) different conference locations, though this is not a requirement.

At 82 the video conferencing system identifies positions of participant persons and/or other objects of interest (white boards, graphic presentations, articles, etc.) within each video feed. In some examples at 84 the video conferencing system defines effective display regions for the video feeds by eliminating portions of the display data areas where no objects of interest are present, for example, conference room areas surrounding the determined positions of the participants/objects that are devoid of any objects or visual data of interest to the participants viewing the conference via the video feeds.

At 86 the video conferencing system determines dimensions of the identified objects of interest (i.e., the positions thereof). In some examples (optionally) the objects are scaled up or down at 88. Scaling may be performed in order to render (scale) each of the persons or objects with generally equivalent size across available display screen elements, thus the scaling for some of the objects may be different for others of the objects having different initial (un-scaled) sizing as positioned in their feeds. Scaling may also ensure, or be limited, to meet some threshold size or quality requirements in displaying identified objects. Thus, to assure that no people or objects are too small to be clearly or adequately discernible within an anticipated display screen size or resolution, or too large (so as to dominate other participants/objects); or that the video data representing the object is not pixilated due to enlarging an object too large for a quality of resolution of the video feed; or to account for a poor quality of video feed; and still other considerations will be apparent to one skilled in the art.

At 90 the video conferencing system determines effective two-dimensional display areas for each of the video feeds in order to effectively display the objects identified within the feeds, as a function of their dimensions determined at 86 (and/or as a function of their dimensions as scaled at 88), and/or the effective display regions determined at 84.

At 92 the video conferencing system distributes the video feeds across a plurality of video display elements as a function of the determined dimensions of the identified positions of the objects of interest (and in some examples as a function of the effective two-dimensional display areas determined for each at 90), to evenly distribute a total plurality of the objects of interest that are present in the video feeds across a cumulative available screen area provided by the plurality of video display elements, to more evenly distribute the crowded object image feed 152 across available screen areas provided by the cumulative area defined by all three screen display elements 102, 104 and 106. The distributing includes differentially distributing portions of a first of the video feeds across more than one of the plurality of screen display elements. Further, in some implementations at least one of the screen display elements depicts portions of one feed along with an entirety of another of the video feeds.

FIG. 5 graphically depicts a perspective of a participant in a conventional, multiple feed video conferencing system presentation, wherein the participant is presented with a display of three different display screen display elements 102, 104 and 106 that each present entireties of different, independent video feeds 152, 154 and 156. The elements 102, 104 and 106 may be distinct and different two-dimensional electronic visual display screens for presentation of images transmitted electronically. Illustrative but not exhaustive electronic visual display screen device examples include cathode ray tube (CRT), Light-emitting diode (LED), electroluminescent (ELD), electronic paper (or “E Ink”), plasma display panel (PDP), liquid crystal display (LCD), High-Performance Addressing display (HPA), Thin-film transistor display (TFT), Organic light-emitting diode display (OLED), and still others will be apparent to one skilled in the art. The elements 102, 104 and 106 may also be distinct and different windows generated within one or more of such display screens, for example, graphical user interface (GUI) windows on a computer display screen. Such windows may be moved about and distributed between two or more display screens, wherein each is driven by a single computer display control unit. Thus the term “screen display elements” as used in the specification and the claims will be understood to be a generic term representative of physical display screen devices, or of windows generated and displayed within such physical display screen devices.

In the present example the screen display elements 102, 104 and 106 have generally equivalent height dimensions 108 and width dimensions 110, though this is not required and their respective dimensions may vary relative to each in other examples. Screen display element 102 presents a first video feed 152 from a first location that depicts a group 112 of five people (164, 166, 168, 170 and 172) attending the conference. Screen display elements 104 and 106 each present different video feeds 154 and 156 from other, second and third locations that each respectively depict only one person 114 and 116 that are also attending the conference.

In the view of FIG. 5, the video feed presentation of the first feed 152 group 112 in screen display element 102 is congested relative to the presentations of the single participants 114 and 116 of screen display elements 104 and 106. As they are the only occupants or objects of interest in their respective feeds 154 and 156, the single participants 114 and 116 also appear much larger than any of the group 112. This may interfere with the ability of the viewer to equally perceive the contributions the different participants to the conference, wherein the presentations of the single participants 114 and 116 have a larger scale relative to each of the group 112 participants 164, 166, 168, 170 and 172, for example calling disproportionately more attention to their facial expressions and any changes therein. This may diminish the impact or importance given to equivalent facial expressions or other visual information (and by extension to their audio contributions) conveyed by the members of the group 112 relative to either of the other participants 114 and 116, as a result of their relatively diminished scale or presentation.

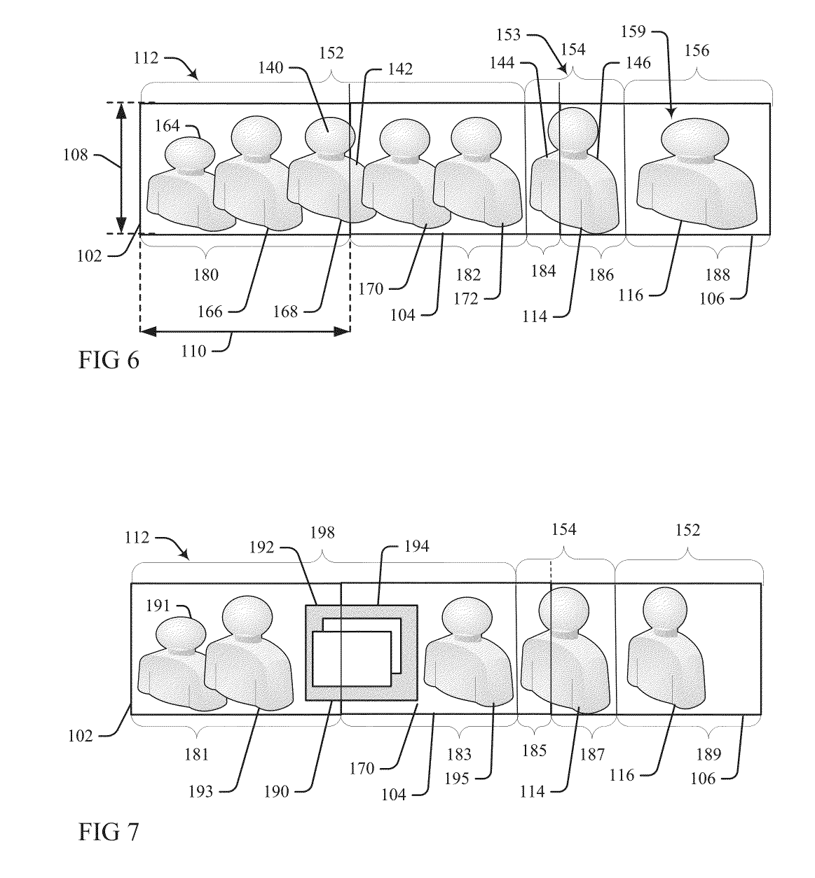

FIG. 6 graphically depicts a perspective of a participant in a multiple feed video conferencing system presentation according to the present invention, wherein a participant is presented with a display of the three different display screen display elements (display screens or windows displayed there within) 102, 104 and 106. The different, independent video feeds 152, 154 and 156 are displayed by the three screen display elements 102, 104 and 106, not in a one-to-one feed to screen display element distribution of FIG. 4, instead by differentially distributing portions of (at least one) of the video feeds across more than one of the screen display elements 102, 104 and 106, and wherein (at least one of) the other screen display element(s) depict(s) portions (and optionally entireties) of more than one of the feeds.

More particularly, in response to determining that the content of the first location 152 has more objects of interest, and is therefore more congested relative to the single person content of the second and third feeds 154 and 156, a video conference management system according to the present invention distributes the image data from the three video feeds 152, 154 and 156 in order to more evenly allocate the objects of interest across the available image areas defined by the respective heights 108 and widths 110 of the screen display elements 102, 104 and 106. Thus, the video conference management system uses an entirety of the display area of the first screen display element 102 to display a portion 180 of the first feed 152 that includes the first two people 164, 166 and a (left-side) portion 140 of the third person 168 of the group of five 112.

The left side of the display area of the second screen display element 104 is used to display a remainder portion 182 of the first feed 152 that includes the remaining (right-side) portion 142 of person 168 and the other people 170 and 172 of the group 112. An effective display region 153 is defined for the video feeds 154 (at 84 of FIG. 4) by eliminating portions 151 and 155 of the display data area that are located on either side of the area 153 about the position identified (at 82 of FIG. 4) of the person 114. The remaining, right-side portion 184 of the second screen display element 104 is used to display this effective display region 153, which includes a (left-side) portion 144 of the second feed 154 that includes a (left-side) portion of the single person 114 of the second feed 154.

A left-side portion 186 of the third screen display element 106 is used to display a remaining (right-side) portion of the display region 153 of the second feed 154 that comprises the remaining, right-side portion 146 of the single person 114. An effective display region 159 is defined for the video feed 156 (at 84 of FIG. 4) by eliminating portions 157 and 161 of the display data area that are located on either side of the area 159 about the position identified (at 82 of FIG. 4) of the person 116. The remaining (right-side) portion 188 of the third screen display element 106 is used to display an entirety of the effective area 159 of the third feed 156 and the single person 116 depicted therein.

(In the present example the effective areas 153 and 159 are demarcated by linear dot-dash lines 171, though other geometric definitions of the area about the defined positions 153 and/or 159 may be practiced.)

Thus, portions of the screen display elements 102, 104 and 106 are shared as needed to reduce congestion caused by the presence of multiple objects of interest within the first feed 152 (here, the people 164, 166, 168, 170 and 172), enabling a relatively larger (wider) display of the first feed 152 video data in FIG. 6, relative to the display areas allocated to the other feeds 154 and 156 across a totality of the display areas available across all three screen display elements 102, 104 and 106.

Embodiments may also identify other objects of interest in the video image data, such as white boards or graphs or other graphic displays, articles of manufacture (models, products), or other objects or visual artifacts that are visible within the video feed content, thereby enhancing the visibility of said objects that would otherwise be reduced by unequal object densities across the different feeds. FIG. 7 illustrates an example wherein a fourth video feed 198 depicts first and second people 191 and 193 located to the left of a white board presentation 190, and a third person 195 depicted to its right. In response to determining that the four objects of interest 190, 191, 193 and 195 results in a congested image composition relative to the single person content of the second and third feeds 154 and 156, a video conference management system according to the present invention uses an entirety of the display area of the first screen display element 102 to display a portion 181 of the fourth feed 189 that includes the first two people 191, 193 and a (left-side) portion 192 of the white board presentation 190. A left side 183 of the display area of the second screen display element 104 is used to display a remainder portion of the fourth feed 198 that includes the remaining (right-side) portion 194 of the white board presentation 190 and the other person 195. The remaining, right-side portion 185 of the second screen display element 104 is used to display the (left-side) portion of the second feed 154 that includes a (left-side) portion of the single person 114 of the second feed 154. A left-side portion 187 of the third screen display element 106 is used to display a remaining (right-side) portion of the second feed 154 that comprises the remaining, right-side portion of the single person 114. The remaining (right-side) portion 189 of the third screen display element 106 is used to display an entirety of the third feed 156 and the single person 116 depicted therein.

By balancing areas allocated as a function of numbers of objects of interest identified and visible across the video feed content of the different feeds, embodiments enhance the visibility of said objects that would otherwise be reduced by unequal object densities across the different feeds. Object and persons may be equally distributed across the total, composite display areas defined by the multiple screen display elements (for example, 102, 104 and 106), or some may be given differentiated scale or space (for example, the enlarged view of the person 116 in FIG. 6 relative to the others).

The allocation and screen display adjustments discussed above may be automatically executed, or they may be suggested to a user for verification. Embodiments also enable manual adjustment and distribution of portions of video feeds across multiple screens, for example, by resizing the windows 102, 104 or 106 using an application on a computer or a remote control device, or adjusting screen areas and distributing video data among multiple screen display elements in response to hand gestures from a user detected and interpreted by the system.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for evenly distributing objects within video content from multiple video feeds across multiple, independent screen display elements, the method comprising:
identifying positions of objects of interest within each of a plurality of video feeds of a video conference, wherein each of the video feeds comprises different objects of interest;
determining dimensions of the identified positions of the objects of interest; and
distributing the video feeds across a plurality of video display elements as a function of the determined dimensions of the identified positions of the objects of interest to evenly distribute a total plurality of the objects of interest that are present in a totality of the video feeds across a cumulative available screen area provided by the plurality of video display elements, wherein the distributing comprises differentially distributing portions of a first of the video feeds across more than one of the plurality of screen display elements.

2. The method of claim 1, further comprising:
integrating computer readable program code into a computer readable storage medium; and
wherein a processor that is in circuit communication with a computer readable memory and the computer readable storage medium executes instructions of the program code integrated on the computer readable storage medium via the computer readable memory and thereby performs the steps of identifying the positions of the objects of interest within each of the plurality of video feeds, determining the dimensions of the identified positions of the objects of interest, and distributing the video feeds across the plurality of screen display elements.

3. The method of claim 1, further comprising:
determining effective two-dimensional display areas for the objects of interest identified within each of the video feeds, by eliminating portions of display data areas surrounding the determined dimensions and positions of the objects of interest that are devoid of the objects of interest; and
wherein the step of distributing the video feeds across the plurality of screen display elements evenly distributes the effective two-dimensional display areas determined for the objects of interest identified within each of the video feeds.

4. The method of claim 1, further comprising:
differential scaling image data of at least one of the objects of interest identified within the video feeds relative to image data of at least one of the objects of interest identified within the video feeds; and
wherein the step of distributing the video feeds across the plurality of screen display elements evenly distributes the effective two-dimensional display areas determined for the objects of interest identified within each of the video feeds as a function of the differentially scaled image data.

5. The method of claim 4, wherein the step of differential scaling comprises scaling each of identified objects of interest to a generally equivalent size for evenly distributing the total plurality of the objects of interest present in the totality of the video feeds across the cumulative available screen area provided by the plurality of screen display elements.

6. The method of claim 4, wherein the step of differential scaling comprises scaling a first object of the identified objects of interest to meet a threshold size to assure that the first object is large enough to be discernible within an anticipated display screen size or resolution of at least one of the screen display elements.

7. The method of claim 4, wherein the step of differential scaling comprises scaling a second object of the identified objects of interest to meet a threshold size to assure that the second object is not pixilated within a resolution of a one of the video feeds comprising the second object.

8. The method of claim 4, wherein the screen display elements are two-dimensional electronic visual display screens, or graphical user interface windows displayed on a computer display screen.

9. A system, comprising:
a processor;
a computer readable memory in circuit communication with the processor; and
a computer readable storage medium in circuit communication with the processor;
wherein the processor executes program instructions stored on the computer readable storage medium via the computer readable memory and thereby:
identifies positions of objects of interest within each of a plurality of video feeds of a video conference, wherein each of the video feeds comprises different objects of interest;
determines dimensions of the identified positions of the objects of interest; and
distributes the video feeds across a plurality of video display elements as a function of the determined dimensions of the identified positions of the objects of interest to evenly distribute a total plurality of the objects of interest that are present in a totality of the video feeds across a cumulative available screen area provided by the plurality of video display elements, wherein the distributing comprises differentially distributing portions of a first of the video feeds across more than one of the plurality of screen display elements.

10. The system of claim 9, wherein the processor executes the program instructions stored on the computer readable storage medium via the computer readable memory and thereby further:
determines effective two-dimensional display areas for the objects of interest identified within each of the video feeds, by eliminating portions of display data areas surrounding the determined dimensions and positions of the objects of interest that are devoid of the objects of interest; and
distributes the video feeds across the plurality of screen display elements by evenly distributing the effective two-dimensional display areas determined for the objects of interest identified within each of the video feeds.

11. The system of claim 9, wherein the processor executes the program instructions stored on the computer readable storage medium via the computer readable memory and thereby further:
differentially scales image data of at least one of the objects of interest identified within the video feeds relative to image data of at least one of the objects of interest identified within the video feeds; and
distributes the video feeds across the plurality of screen display elements by evenly distributing the effective two-dimensional display areas determined for the objects of interest identified within each of the video feeds as a function of the differentially scaled image data.

12. The system of claim 11, wherein the processor executes the program instructions stored on the computer readable storage medium via the computer readable memory and thereby further:
differentially scales image data of each of identified objects of interest to a generally equivalent size; and
evenly distributes the total plurality of the objects of interest present in the totality of the video feeds across the cumulative available screen area provided by the plurality of screen display elements in their generally equivalent sizes.

13. The system of claim 11, wherein the processor executes the program instructions stored on the computer readable storage medium via the computer readable memory and thereby further:
differentially scales a first object of the identified objects of interest to meet a threshold size to assure that the first object is large enough to be discernible within an anticipated display screen size or resolution of at least one of the screen display elements.

14. The system of claim 11, wherein the processor executes the program instructions stored on the computer readable storage medium via the computer readable memory and thereby further:
differentially scales a second object of the identified objects of interest to meet a threshold size to assure that the second object is not pixilated within a resolution of a one of the video feeds comprising the second object.

15. A computer program product for evenly distributing objects within video content from multiple video feeds across multiple, independent screen display elements, the computer program product comprising:
a computer readable storage medium having computer readable program code embodied therewith, the computer readable program code comprising instructions for execution by a processor that cause the processor to:
identify positions of objects of interest within each of a plurality of video feeds of a video conference, wherein each of the video feeds comprises different objects of interest;
determine dimensions of the identified positions of the objects of interest; and
distribute the video feeds across a plurality of video display elements as a function of the determined dimensions of the identified positions of the objects of interest to evenly distribute a total plurality of the objects of interest that are present in a totality of the video feeds across a cumulative available screen area provided by the plurality of video display elements, wherein the distributing comprises differentially distributing portions of a first of the video feeds across more than one of the plurality of screen display elements.

16. The computer program product of claim 15, wherein the computer readable program code instructions for execution by the processor further cause the processor to:
determine effective two-dimensional display areas for the objects of interest identified within each of the video feeds, by eliminating portions of display data areas surrounding the determined dimensions and positions of the objects of interest that are devoid of the objects of interest; and
distribute the video feeds across the plurality of screen display elements by evenly distributing the effective two-dimensional display areas determined for the objects of interest identified within each of the video feeds.

17. The computer program product of claim 15, wherein the computer readable program code instructions for execution by the processor further cause the processor to:
differentially scale image data of at least one of the objects of interest identified within the video feeds relative to image data of at least one of the objects of interest identified within the video feeds; and
distribute the video feeds across the plurality of screen display elements by evenly distributing the effective two-dimensional display areas determined for the objects of interest identified within each of the video feeds as a function of the differentially scaled image data.

18. The computer program product of claim 17, wherein the computer readable program code instructions for execution by the processor further cause the processor to:
differentially scale image data of each of identified objects of interest to a generally equivalent size; and
evenly distribute the total plurality of the objects of interest present in the totality of the video feeds across the cumulative available screen area provided by the plurality of screen display elements in their generally equivalent sizes.

19. The computer program product of claim 17, wherein the computer readable program code instructions for execution by the processor further cause the processor to:
differentially scale a first object of the identified objects of interest to meet a threshold size to assure that the first object is large enough to be discernible within an anticipated display screen size or resolution of at least one of the screen display elements.

20. The computer program product of claim 17, wherein the computer readable program code instructions for execution by the processor further cause the processor to:
differentially scale a second object of the identified objects of interest to meet a threshold size to assure that the second object is not pixilated within a resolution of a one of the video feeds comprising the second object.
